(19) United States
(12) Patent Application Publication
(10) Pub. No.: US 2025/0323305 A1
(43) Pub. Date: Oct. 16, 2025

(54) FUEL CELL MODULE

(71) Applicant: TOYOTA JIDOSHA KABUSHIKI KAISHA, Toyota-shi (JP)

(72) Inventor: Daisuke ISHIKAWA, Seto-shi (JP)

(73) Assignee: TOYOTA JIDOSHA KABUSHIKI KAISHA, Toyota-shi (JP)

(21) Appl. No.: 19/071,011

(22) Filed: Mar. 5, 2025

(30) Foreign Application Priority Data
Apr. 16, 2024 (JP) 2024-066145

(51) Int. Cl. H01M 8/2475; H01M 8/04082

(52) U.S. Cl. CPC H01M 8/2475; H01M 8/04201; H01M 2250/20

(57) ABSTRACT

The fuel cell module includes an auxiliary device assembly including a fuel cell stack and an air compressor, and a frame member supporting the auxiliary device assembly. The frame member includes: a pair of side members extending in a first direction; a pair of cross members extending along a second direction perpendicular to the first direction, arranged in a rectangular shape together with the side members, and shorter than the side members; and four connecting members connecting the side members and the cross members arranged in a rectangular shape to each other. The fuel cell stack is fixed to each of the side members and is fixed to one of the cross members or a connecting member connected thereto. The auxiliary device assembly is fixed to each of the side members and is fixed to the other of the cross members or a connecting member connected thereto.

### CROSS-REFERENCE TO RELATED APPLICATION

This application claims priority to Japanese Patent Application No. 2024-066145 filed on Apr. 16, 2024, incorporated herein by reference in its entirety.

### BACKGROUND

### 1. Technical Field

The technology disclosed herein relates to a fuel cell module mounted on a vehicle.

### 2. Description of Related Art

Japanese Unexamined Patent Application Publication No. 2022-86178 (JP 2022-86178 A) describes a fuel cell module mounted on a vehicle. The fuel cell module includes a fuel cell stack, a plurality of auxiliary devices that drives the fuel cell stack, and a rectangular frame member that supports them. The frame member includes a pair of side members and a pair of cross members shorter than the side members.

### SUMMARY

Since the fuel cell stack and the auxiliary devices are heavy objects, when vibration is input from a vehicle body to the frame member, relatively large vibration may occur in the entire fuel cell module. As a result, deformation such as bending or twisting may occur in the frame member. Therefore, the frame member for fixing the heavy objects such as the fuel cell stack and the auxiliary devices as in JP 2022-86178 A may be provided with a reinforcing member extending over the side members to reinforce the frame member. However, the number of components constituting the frame member increases due to the added reinforcing member, and the weight of the fuel cell module increases. In view of the above problem, the present specification provides a technology capable of reducing the weight of a fuel cell module.

The technology disclosed herein is embodied in a fuel cell module to be mounted on a vehicle. In a first aspect of the present technology, the fuel cell module may include: a fuel cell stack including a plurality of fuel cells; an auxiliary device assembly including an air compressor configured to supply air to the fuel cell stack; and a frame member that supports the fuel cell stack and the auxiliary device assembly. The frame member may include: a pair of side members extending in a first direction in which the fuel cell stack and the auxiliary device assembly are arranged; a pair of cross members extending along a second direction perpendicular to the first direction, arranged in a rectangular shape together with the side members, and shorter than the side members; and four connecting members that connect the side members and the cross members arranged in the rectangular shape. The fuel cell stack may be fixed to the side members and may be fixed to one of the cross members or the connecting members connected to the one of the cross members. The auxiliary device assembly may be fixed to the side members and may be fixed to the other of the cross members or the connecting members connected to the other of the cross members.

In the above configuration, the fuel cell stack and the auxiliary device assembly are fixed to the side members. With such a configuration, the fuel cell stack and the auxiliary device assembly fixed across the side members can also function as a reinforcing member for reinforcing the frame member. Therefore, deformation of the frame member caused by the fuel cell stack and the auxiliary device assembly that are heavy objects can be suppressed without providing an additional reinforcing member to the frame member. In addition, the number of components of the frame member is relatively reduced, and the weight of the fuel cell module is reduced.

In a second aspect of the present technology, in the first aspect, each of the four connecting members may include an attachment portion to be attached to a vehicle body of the vehicle. In this case, the fuel cell stack may be fixed near the attachment portion of the connecting member. The attachment portion attached to the vehicle body is a portion of the frame member that is hard to be elastically deformed. When the fuel cell stack is fixed near such an attachment portion, vibration generated in the frame member or the fuel cell stack is suppressed, for example, while the vehicle is traveling.

In a third aspect of the present technology, in the first or second aspect, the auxiliary device assembly may further include a relay box disposed below the air compressor, and a bracket that fixes the air compressor to the frame member. In this case, the relay box may include a first connector electrically connected to the fuel cell stack, and a second connector electrically connected to the air compressor. The bracket may include a plate-shaped portion interposed between the air compressor and the relay box, and a plurality of legs provided to the plate-shaped portion and extending from the plate-shaped portion to the frame member. The legs may fix the relay box to the frame member. In such a configuration, the air compressor and the relay box are fixed together to the frame member by the common bracket. Thus, the rigidity of the entire auxiliary device assembly increases.

In a fourth aspect of the present technology, in any one of the first to third aspects, each of the side members and the cross members may have a tubular shape. With such a configuration, the side members and the cross members have high rigidity. Thus, elastic deformation and vibration occurring in the frame member are suppressed.

In a fifth aspect of the present technology, in the fourth aspect, each of the side members or each of the cross members may be provided with a through collar extending from an upper wall to a lower wall. In this case, at least one of the legs may be fixed by a bolt passing through the through collar. With such a configuration, in each of the side members or the cross members provided with the through collar, the rigidity against a load in an up-down direction is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows a plan view of a fuel cell module;

FIG. 2 shows a plan view of a frame member;

FIG. 3 shows a side view of the fuel cell module when viewed from one side in the second direction;

FIG. 4 shows a side view of the fuel cell module as viewed from the other side in the first direction; and

FIG. 5 shows a cross-sectional view along V-V line of FIG. 1.

### DETAILED DESCRIPTION OF EMBODIMENTS

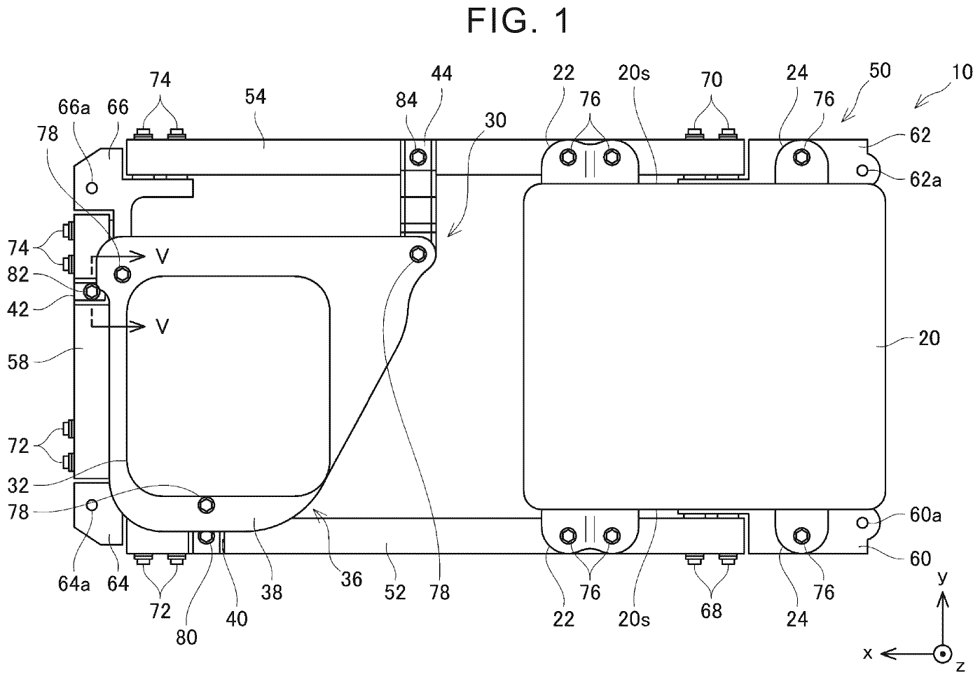

A fuel cell module 10 according to an embodiment will be described with reference to the drawings. The fuel cell module 10 is mounted on vehicles such as battery electric vehicle. The fuel cell module 10 supplies the generated electric power to battery electric vehicle driving motor. Alternatively, the fuel cell system 100 charges the battery of battery electric vehicle by the generated electric power. As illustrated in FIG. 1, the fuel cell module 10 includes a fuel cell stack 20, an auxiliary device assembly 30, and a frame member 50. The frame member 50 supports the fuel cell stack 20 and the auxiliary device assembly 30.

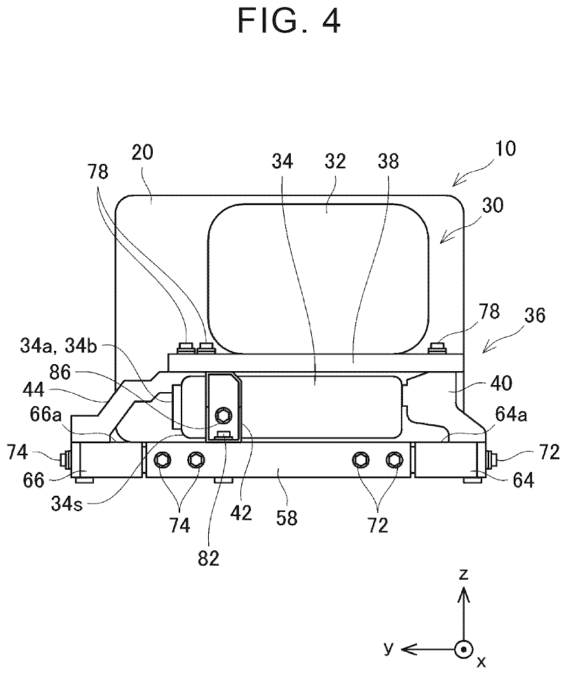

As shown in FIGS. 1, 3, and 4, the fuel cell stack 20 is disposed on the frame member 50. The fuel cell stack 20 includes a plurality of fuel cells. In each of the plurality of fuel cells, the fuel gas and the air react to generate electric power. In this embodiment, the fuel gas is hydrogen.

The auxiliary device assembly 30 is disposed on the frame member 50. The auxiliary device assembly 30 includes an air compressor 32 and a relay box 34. The air compressor 32 supplies air to the fuel cell stack 20. The relay box 34 is electrically connected to the fuel cell stack 20 and the air compressor 32. The relay box 34 is also referred to as a junction box. The relay box 34 has a first connector 34a and a second connector 34b arranged on a side surface 34s thereof. The first connector 34a is electrically connected to the fuel cell stack 20, and the second connector 34b is electrically connected to the air compressor 32. The relay box 34 is disposed below the air compressor 32. The auxiliary device assembly 30 is arranged along the first direction with the fuel cell stack 20.

Here, the first direction in the present specification means a direction in which the fuel cell stack 20 and the auxiliary device assembly 30 are arranged, and is defined by the x-axis in the drawing. The up-down direction means a direction in which the frame member 50 and the fuel cell stack 20 are arranged, and is defined by the z-axis in the drawing. The second direction means a direction perpendicular to each other in the first direction and the up-down direction, and is defined by the y-axis in the drawing. In this specification, the negative orientation of the x-axis, i.e., the right side of the page of FIG. 1, is represented as one side of the first direction, and the positive orientation of the x-axis, i.e., the left side of the page of FIG. 1, is represented as the other side of the first direction. The negative orientation of the y-axis, i.e., the lower side of the page in FIG. 1, is represented as one side in the second direction, and the positive orientation of the y-axis, i.e., the upper side of the page in FIG. 1, is represented as the other side in the second direction. The negative orientation of the z-axis, i.e., the depth side of the page in FIG. 1, is represented as the lower side in the up-down direction, and the positive orientation of the z-axis, i.e., the near side of the page in FIG. 1, is represented as the upper side in the up-down direction.

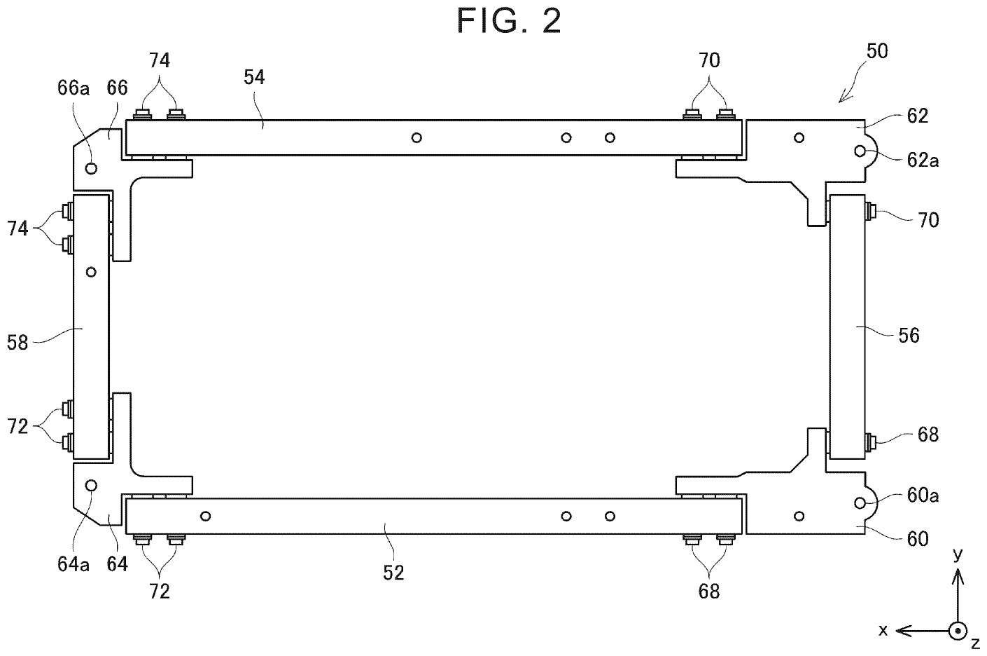

As shown in FIG. 2, the frame member 50 is a rectangular member. It has a pair of side members 52, 54, a pair of cross members 56, 58, and four connecting members 60, 62, 64, 66. The pair of side members 52 and 54 and the pair of cross members 56 and 58 are rectangular cylindrical members. According to such a configuration, the side members 52 and 54 and the cross members 56 and 58 have high rigidity, so that elastic deformation and vibration generated in the frame member 50 are suppressed. The pair of side members 52 and 54 and the pair of cross members 56 and 58 are made of a metal such as steel.

The pair of side members 52 and 54 extend along the first direction (i.e., the x-axis direction). The pair of side members 52 and 54 are spaced apart from each other in the second direction (i.e., the y-axis direction). The pair of side members 52 and 54 have a first side member 52 positioned on one side in the second direction and a second side member 54 positioned on the other side in the second direction.

The pair of cross members 56, 58 is shorter than the pair of side members 52, 54. The pair of cross members 56, 58 extend along the second direction. The pair of cross members 56, 58 are spaced apart from each other in the first direction. The pair of cross members 56 and 58 includes a first cross member 56 positioned on one side in the first direction and a second cross member 58 positioned on the other side in the first direction. The pair of cross members 56 and 58 are arranged in a rectangular shape together with the pair of side members 52 and 54.

25 The four connecting members 60, 62, 64, 66 are cast iron members. The four connecting members 60, 62, 64, and 66 connect the pair of side members 52 and 54 arranged in a rectangular shape and the pair of cross members 56 and 58 to each other. The four connecting members 60, 62, 64, and 66 include a first connecting member 60, a second connecting member 62, a third connecting member 64, and a fourth connecting member 66. The first connecting member 60 connects one end of the first side member 52 and one end of the first cross member 56 to each other. The first connecting member 60 is fastened to the first side member 52 and the first cross member 56 by fastening members 68 such as one or a plurality of bolts. The first connecting member 60 has an attachment portion 60a that is attached to a vehicle body of the vehicle. Similar to the first connecting member 60, the other connecting members 62, 64, and 66 are similarly configured.

The second connecting member 62 connects one end of the second side member 54 and the other end of the first cross member 56 to each other. The second connecting member 62 is fastened to the second side member 54 and the first cross member 56 by fastening members 70 such as one or a plurality of bolts. The second connecting member 62 has an attachment portion 62a attached to the vehicle body.

The third connecting member 64 connects the other end of the first side member 52 and one end of the second cross member 58 to each other. The third connecting member 64 is fastened to the first side member 52 and the second cross member 58 by fastening members 72 such as one or a plurality of bolts. The third connecting member 64 has an attachment portion 64a attached to the vehicle body.

The fourth connecting member 66 connects the other end of the second side member 54 and the other end of the second cross member 58 to each other. The fourth connecting member 66 is fastened to the second side member 54 and the second cross member 58 by fastening members 74 such as one or a plurality of bolts. The fourth connecting member 66 has an attachment portion 66a attached to the vehicle body.

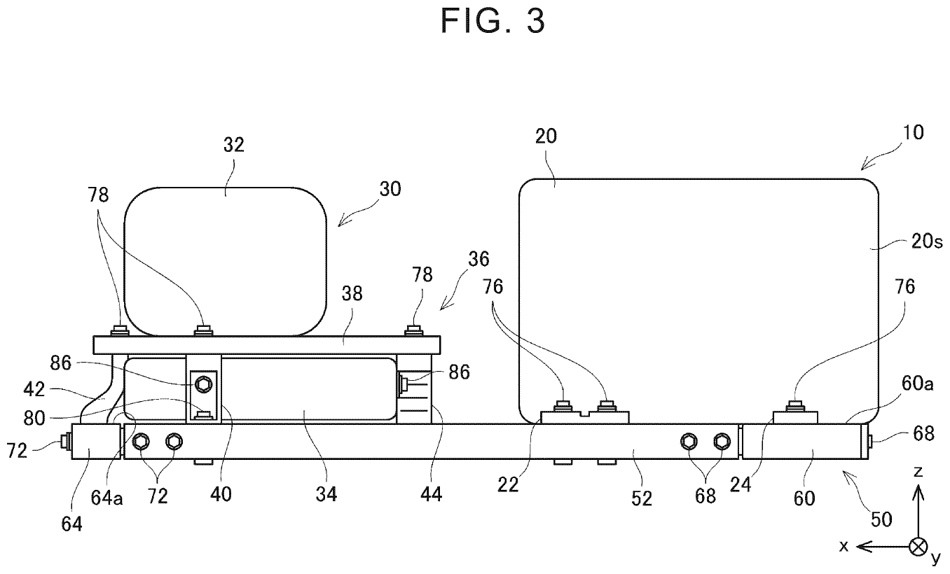

Referring to FIGS. 1 and 3, a structure for fixing the fuel cell stack 20 to the frame member 50 will be described. The fuel cell stack 20 has a plurality of fixing portions 22 and 24 extending from the side surface 20s of the fuel cell stack 20 to both sides in the second direction. The plurality of fixing portions 22 and 24 includes a pair of first fixing portions 22 that fix the fuel cell stack 20 to the pair of side members 52 and 54, and a pair of second fixing portions 24 that fix the fuel cell stack 20 to the first connecting member 60 and the second connecting member 62. Accordingly, the fuel cell stack 20 is fixed to each of the pair of side members 52 and 54, and is fixed to each of the first connecting member 60 and the second connecting member 62.

In the pair of second fixing portions 24, the fuel cell stack 20 is fixed in the vicinity of the attachment portion 60a, 62a of the first connecting member 60 and the second connecting member 62. The attachment portion 60a, 62a attached to the vehicle body is a part of the frame member 50 that is hard to be elastically deformed. When the fuel cell stack 20 is fixed in the vicinity of the attachment portion 60a, 62a, for example, vibrations generated in the frame member 50 and the fuel cell stack 20 when the vehicle travels are suppressed. The plurality of fixing portions 22 and 24 are fastened to the frame member 50 by fastening members 76 such as bolts. However, in the modified example, the fuel cell stack 20 may be connected to the first cross member 56 instead of the first connecting member 60 and the second connecting member 62.

A structure for fixing the auxiliary device assembly 30 to the frame member 50 will be described. The auxiliary device assembly 30 includes a bracket 36 that secures the air compressor 32 to the frame member 50. The bracket 36 includes a plate-shaped portion 38 and a plurality of (three in the present embodiment) legs 40, 42, and 44. The plate-shaped portion 38 is a plate-shaped member and is interposed between the air compressor 32 and the relay box 34. The plurality of legs 40, 42, 44 are bent plate-like members. Each of the plurality of legs 40, 42, and 44 is fastened to the plate-shaped portion 38 by a fastening member 78 such as a bolt. The plurality of legs 40, 42, and 44 extend downward from the plate-like portion 38 toward the frame member 50. The plurality of legs 40, 42, 44 have a first leg 40, a second leg 42, and a third leg 44. The first leg 40 is fastened to the first side member 52 by a fastening member 80 such as a bolt. The second leg 42 is fastened to the second cross member 58 by a fastening member 82 such as a bolt. The third leg 44 is fastened to the second side member 54 by a fastening member 84 such as a bolt. Thus, the auxiliary device assembly 30 is fixed to each of the pair of side members 52 and 54, and is fixed to the second cross member 58. However, in the modified example, the auxiliary device assembly 30 may be connected to at least one of the third connecting member 64 and the fourth connecting member 66 instead of the second cross member 58.

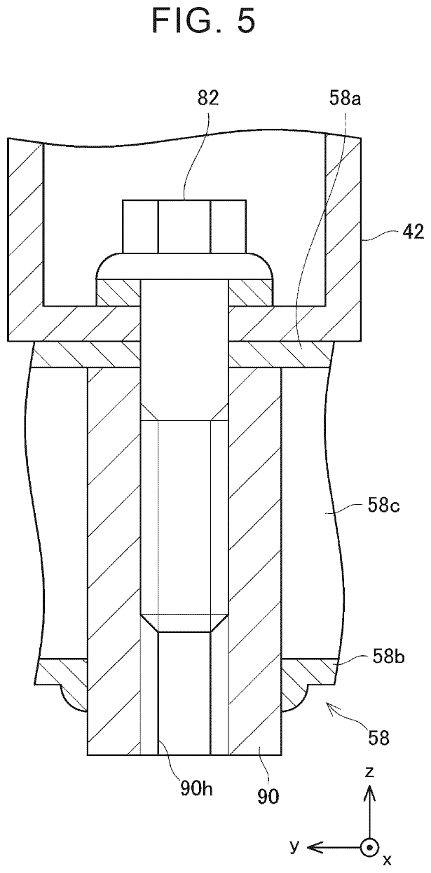

With reference to FIG. 5, the fixing structure of the frame member 50 and the bracket 36 will be described by taking the second cross member 58 and the second leg 42 as an example. As shown in FIG. 5, the second cross member 58 is a cylindrical member having a rectangular shape as described above, and has an upper wall 58a, a lower wall 58b located on the other side, and a pair of side wall 58c extending between the upper wall 58a and the lower wall 58b. The second cross member 58 has a through collar 90. The through collar 90 extends from the upper wall 58a to the lower wall 58b inside the second cross member 58. The through collar 90 is a cylindrical member having a through hole 80h extending from the upper wall 58a to the lower wall 58b. The second legs 42 are fixed by fastening members 82 such as bolts passing through the through-holes 90h of the through collar 90. The through collar 90 is made of a metal material. The first cross member 56, the first side member 52, and the second side member 54 are configured similarly to the second cross member 58, and each has a through collar. Similar to the second leg 42, the first leg 40 is fixed to the first side member 52 and the third leg 44 is fixed to the second side member 54. According to such a configuration, in the pair of side members 52 and 54 or the pair of cross members 56 and 58 provided with the through collar, the rigidity with respect to the load from the vertical direction is improved. However, the present disclosure is not limited to all of the plurality of legs 40, 42, and 44, and at least one of the plurality of legs 40, 42, and 44 may be fixed by bolts passing through the through collar.

Each of the plurality of legs 40, 42, and 44 is connected to the relay box 34 by a fastening member 86 such as a bolt. Accordingly, the plurality of legs 40, 42, and 44 fix the relay box 34 to the frame member 50.

In the fuel cell module 10 according to the present embodiment, the fuel cell stack 20 and the auxiliary device assembly 30 are fixed to the pair of side members 5 and 54, respectively. According to such a configuration, the fuel cell stack 20 and the auxiliary device assembly 30 fixed across the pair of side members 52 and 54 can also function as a reinforcing member for reinforcing the frame member 50. Therefore, it is possible to suppress deformation of the frame member 50 caused by the fuel cell stack 20 and the auxiliary device assembly 30, which are heavy objects, without providing an additional reinforcing member in the frame member 50. As a result, the number of components of the frame member 50 is relatively reduced, and the weight of the fuel cell module 10 is reduced.

In the present embodiment, the auxiliary device assembly 30 fixes the air compressor 32 to the frame member 50 by the bracket 36. The bracket 36 includes a plate-shaped portion 38 interposed between the air compressor 32 and the relay box 34, and a plurality of legs 40, 42, and 44 provided in the plate-shaped portion 38 and extending from the plate-shaped portion 38 to the frame member 50. Further, the bracket 36 also fixes the relay box 34 to the frame member 50 by the plurality of legs 40, 42, 44 of the bracket 36. According to such a configuration, the air compressor 32 and the relay box 34 are integrally fixed to the frame member 50 by the common bracket 36. This increases the stiffness of the entire auxiliary device assembly 30.

The auxiliary device assembly 30 may include other accessories for driving the fuel cell stack 20 in addition to the air compressor 32 and the relay box 34 described above. Other accessories may include, for example, a converter for the air compressor 32, a water pump for circulating coolant for cooling the fuel cell stack 20, and the like.

What is claimed is:

1. A fuel cell module to be mounted on a vehicle, the fuel cell module comprising:
a fuel cell stack including a plurality of fuel cells;
an auxiliary device assembly including an air compressor configured to supply air to the fuel cell stack; and
a frame member that supports the fuel cell stack and the auxiliary device assembly, wherein
the frame member includes:
a pair of side members extending in a first direction in which the fuel cell stack and the auxiliary device assembly are arranged;
a pair of cross members extending along a second direction perpendicular to the first direction, arranged in a rectangular shape together with the side members, and shorter than the side members; and
four connecting members that connect the side members and the cross members arranged in the rectangular shape,
the fuel cell stack is fixed to the side members and is fixed to one of the cross members or the connecting members connected to the one of the cross members, and
the auxiliary device assembly is fixed to the side members and is fixed to the other of the cross members or the connecting members connected to the other of the cross members.

2. The fuel cell module according to claim 1, wherein:
each of the four connecting members includes an attachment portion to be attached to a vehicle body of the vehicle; and
the fuel cell stack is fixed near the attachment portion of the connecting member.

3. The fuel cell module according to claim 1, wherein:
the auxiliary device assembly further includes a relay box disposed below the air compressor, and a bracket that fixes the air compressor to the frame member;
the relay box includes a first connector electrically connected to the fuel cell stack, and a second connector electrically connected to the air compressor;
the bracket includes a plate-shaped portion interposed between the air compressor and the relay box, and a plurality of legs provided to the plate-shaped portion and extending from the plate-shaped portion to the frame member; and
the legs fix the relay box to the frame member.

4. The fuel cell module according to claim 3, wherein each of the side members and the cross members has a tubular shape.

5. The fuel cell module according to claim 4, wherein:
each of the side members or each of the cross members is provided with a through collar extending from an upper wall to a lower wall; and
at least one of the legs is fixed by a bolt passing through the through collar.
